(19) United States
(12) Patent Application Publication
(10) Pub. No.: US 2026/0116371 A1
(43) Pub. Date: Apr. 30, 2026

(54) EV LINE VARIABLE CONTROL SYSTEM AND METHOD FOR ELECTRIFIED VEHICLE

(71) Applicants: Hyundai Motor Company, Seoul (KR); Kia Corporation, Seoul (KR)

(72) Inventor: Jee Wook Huh, Hwaseong-si (KR)

(73) Assignees: Hyundai Motor Company, Seoul (KR); KIA Corporation, Seoul (KR)

(21) Appl. No.: 19/214,683

(22) Filed: May 21, 2025

(30) Foreign Application Priority Data
Oct. 25, 2024 (KR) 10-2024-0147113

(51) Int. Cl. B60W 20/13; B60L 58/13; B60W 20/12

(52) U.S. Cl. CPC B60W 20/13; B60L 58/13; B60W 20/12; B60L 2240/26; B60L 2240/46; B60L 2240/622; B60L 2240/642; B60L 2240/68; B60W 2530/10; B60W 2530/20

(57) ABSTRACT

EV line variable control system and method for a hybrid vehicle may enable the variable control of an EV line based on total driving energy and required charging and discharging energy while the vehicle is driving on a pre-set specific driving route to lower the EV line by a certain level, so that before the vehicle reaches a destination for using a stay mode, a battery SOC may be managed in advance as a target battery SOC higher than a reference SOC.

### CROSS REFERENCE TO RELATED APPLICATION

The present application claims priority to Korean Patent Application No. 10-2024-0147113, filed Oct. 25, 2024, the entire contents of which is incorporated herein for all purposes by this reference.

### BACKGROUND OF THE PRESENT DISCLOSURE

### Field of the Present Disclosure

The present disclosure relates generally to electric vehicle (EV) line variable control system and method for an electrified vehicle. More particularly, the present disclosure relates to EV line variable control system and method for an electrified vehicle that enables the variable control of an EV line based on total driving energy and a required charging and discharging energy within a specific driving route.

### Description of Related Art

As is well known, a hybrid vehicle, which is a type of electric vehicle, is a vehicle equipped with both a motor and an engine, and provides an electric vehicle (EV) mode for driving solely on motor power, and a hybrid electric vehicle (HEV) mode for driving on engine power and motor power.

While a hybrid vehicle is driving in an EV mode, an engine thereof is turned on to switch to an HEV mode, and while the hybrid vehicle is driving in the HEV mode, the engine is turned off to switch to the EV mode. To improve fuel efficiency, efficient engine-on control or engine-off control is required.

To the present end, an EV line is used to control the engine ON/OFF of a hybrid vehicle.

The EV line, which is a reference line for determining an engine ON/OFF timing, includes an EV online that determines the engine-on timing and an EV offline that determines the engine-off timing, and may be constructed with a plurality of map data based on battery State of Charge (SOC) and driver demand power.

Accordingly, while the hybrid vehicle is driving, a controller may use the map data to determine the on or off timing of an engine, and may perform engine-on control or engine-off control based on the determined on or off timing.

Meanwhile, research and development are underway to utilize a vehicle as an indoor living space for rest, sleep, and recreational activities rather than simply as a means of transportation.

As an example, a stay mode is being researched and developed so that while a hybrid vehicle is parked in a specific location, a motor generates power through rotation force generated by engine idling to charge a battery, allowing the vehicle to continue using the power of the battery for various indoor and outdoor activities.

To use the present stay mode, a method is required to manage the SOC value of the battery in advance to a higher level than a reference level while the vehicle is driving immediately before reaching a parking space.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing EV line variable control system and method for a hybrid vehicle that enable the variable control of an EV line based on total driving energy and required charging and discharging energy while the vehicle is driving on a pre-set specific driving route to lower the EV line by a certain level, so that before the vehicle reaches a destination for using a stay mode, a battery SOC may be managed in advance as a target battery SOC higher than a reference SOC.

To achieve the objectives, in an exemplary embodiment of the present disclosure, there is provided an EV line variable control system for an electrified vehicle, the system including: an input device for entering whether or not to perform EV line variable control; a navigation device configured to provide a vehicle controller with EV line variable control information including traffic information, current location information, and road gradient information to a destination for a stay mode of the vehicle; and the vehicle controller configured to determine total driving energy required to reach the destination based on the EV line variable control information received from the navigation device according to a request of the EV line variable control received through the input device, to determine required charging and discharging energy based on a current battery SOC value and a preset target battery SOC value, and to determine an EV line variability amount and a final EV line based on the total driving energy and the required charging and discharging energy.

In the exemplary embodiment of the present disclosure, the vehicle controller may be configured to determine a distance to the destination for the stay mode input through the navigation device as an EV line variable control impossible distance when the distance is less than a reference distance, to determine the distance as an EV line variable control possible distance when the distance is greater than or equal to the reference distance, and to output a message indicating the EV line variable control impossible distance on a display.

In the exemplary embodiment of the present disclosure, the vehicle controller may be configured to determine vehicle air resistance, rolling resistance, grade resistance, and acceleration resistance based on information on average vehicle speed and at least one of vehicle acceleration information or vehicle deceleration information of a driving road to the destination, and information on a predetermined vehicle weight and a tire rolling radius as well as the traffic information, the current location information, and the road gradient information received from the navigation device, and to determine the total driving energy by integrating the air resistance, the rolling resistance, the grade resistance, and the acceleration resistance which are determined.

In the exemplary embodiment of the present disclosure, the vehicle controller may be configured to determine a required charging and discharging SOC value by subtracting the target battery SOC from a reference SOC value, and to determine the required charging and discharging energy based on the required charging and discharging SOC value, which is determined, and a battery capacity, and the required charging and discharging energy is determined by multiplying the required charging and discharging SOC value by the battery capacity.

In the exemplary embodiment of the present disclosure, the vehicle controller may be configured to determine an EV line variability rate based on the total driving energy and the required charging and discharging energy, to determine the EV line variability amount based on the EV line variability rate, and to determine the final EV line adjusted downward by a predetermined level compared to an existing EV line based on the EV line variability amount.

The EV line variability rate may be determined by dividing the required charging and discharging energy by the total driving energy, the EV line variability amount may be determined by multiplying the existing EV line by the EV line variability rate, and the final EV line may be determined to be at a level reduced by the EV line variability amount compared to the existing EV line.

In the exemplary embodiment of the present disclosure, the system may further include: an engine controller configured to perform engine-on control or engine-off control based on the final EV line commanded from the vehicle controller; a power generation device configured to generate power by rotation force generated by engine operation during the engine-on control; and a battery controller configured to control charging of the generated power of the power generation device into the energy storage system.

To achieve the objectives, in another exemplary embodiment of the present disclosure, there is provided an EV line variable control method for an electrified vehicle, the method including: determining, by a vehicle controller, whether EV line variable control is possible when requesting the EV line variable control through an input device; receiving, by the vehicle controller, EV line variable control information including traffic information, current location information, and road gradient information to a destination input through a navigation device when the EV line variable control is possible; and determining, by the vehicle controller, total driving energy required to reach the destination based on the EV line variable control information received from the navigation device, determining required charging and discharging energy based on a current battery SOC value and a preset target battery SOC value, and determining an EV line variability amount and a final EV line based on the total driving energy and the required charging and discharging energy.

According to another exemplary embodiment of the present disclosure, in the determining of whether the EV line variable control is possible, when a distance of the vehicle to the destination for a stay mode input through the navigation device is less than a reference distance, the distance may be determined as an EV line variable control impossible distance, when the distance is greater than or equal to the reference distance, the distance may be determined as an EV line variable control possible distance, and a message indicating the EV line variable control impossible distance may be output on a display.

In the another exemplary embodiment of the present disclosure, the total driving energy may be determined by determining vehicle air resistance, rolling resistance, grade resistance, and acceleration resistance based on information on average vehicle speed and at least one of vehicle acceleration information or vehicle deceleration information of a driving road to the destination, and information of a predetermined vehicle weight and a tire rolling radius as well as the traffic information, the current location information, and the road gradient information received from the navigation device, and integrating the air resistance, the rolling resistance, the grade resistance, and the acceleration resistance which are determined.

In the another exemplary embodiment of the present disclosure, the required charging and discharging energy may be determined based on a required charging and discharging SOC value determined by subtracting the target battery SOC from a reference SOC value, and a battery capacity, and may be determined by multiplying the required charging and discharging SOC value by the battery capacity.

In the another exemplary embodiment of the present disclosure, when the EV line variability amount and the final EV line are determined, an EV line variability rate may first be determined based on the total driving energy and the required charging and discharging energy, the EV line variability amount may be determined based on the EV line variability rate, and then the final EV line adjusted downward by a predetermined level compared to an existing EV line may be determined based on the EV line variability amount.

The EV line variability rate may be determined by dividing the required charging and discharging energy by the total driving energy, the EV line variability amount may be determined by multiplying the existing EV line by the EV line variability rate, and the final EV line may be determined to be at a level reduced by the EV line variability amount compared to the existing EV line.

In the another exemplary embodiment of the present disclosure, the method may further include: performing, by an engine controller, engine-on control or engine-off control based on the final EV line commanded from the vehicle controller; generating, by a power generation device, power by rotation force generated by engine operation during the engine-on control; and controlling, by a battery controller, charging of the generated power of the power generation device into the energy storage system.

Through the means of solving the above-mentioned problem, the present disclosure provides the following effects.

First, by variably controlling the EV line when a vehicle drives on a preset specific driving route, the EV line may be lowered by a predetermined level compared to a previous EV line, increasing the driving amount and driving time of an engine according to driver demand power, and accordingly, increasing the battery SOC due to the generation of the power generation device generation according to the operation of the engine.

Second, the battery SOC is increased in advance to a target battery SOC higher than the reference SOC before reaching a destination for using the stay mode, facilitating power usage for the stay mode at the destination.

Third, the EV line variable control may be realized to provide convenience in the development of EV line control logic, and the number of EV line map data may be reduced to simplify the EV line control logic and minimize heterogeneity in the EV line control logic.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a powertrain diagram of a hybrid vehicle to which EV line variable control is applied according to an exemplary embodiment of the present disclosure;

FIG. 2 is a control schematic diagram illustrating an EV line variable control system for an electrified vehicle according to an exemplary embodiment of the present disclosure;

FIG. 3 is a flowchart illustrating an EV line variable control method for an electrified vehicle according to an exemplary embodiment of the present disclosure;

FIG. 4 is a graph illustrating a method for extracting a reference SOC for the EV line variable control of the electrified vehicle according to an exemplary embodiment of the present disclosure; and

FIG. 5 is a graph illustrating an example of an EV line being adjusted downward compared to the existing EV line based on the EV line variable control method for an electrified vehicle according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Descriptions described in the exemplary embodiment of the present specification are merely intended to explain the exemplary embodiment according to the concept of the present disclosure. The exemplary embodiment according to the concept of the present disclosure may be implemented in various forms, and the present disclosure should not be construed as limited by the exemplary embodiment described in the present specification, but should be understood to include all modifications, equivalents and substitutes included in the idea and technical scope of the present disclosure.

In the present specification, terms such as first and/or second may be used to describe various components, but the components are not limited by the terms. The terms are used only for distinguishing one component from other components. For example, without departing from the scope of the claims according to the concept of the present disclosure, a first component may be named a second component, and similarly, the second component may be named the first component.

Like reference numerals refer to like elements throughout the present specification. Terms used herein are for descriptive purposes only and is not intended to limit the present disclosure. In the present specification, singular forms also include plural forms unless specifically stated in phrases. As used herein, “comprises” and/or “comprising” means that a referenced component, step, operation and/or element do not exclude the presence or addition of one or more other components, steps, operations and/or elements.

An electrified vehicle to which the system and method of the present disclosure are applied may be a hybrid vehicle and a fuel cell vehicle provided with a high-voltage battery, a self-powered power generation device that generates power by use of fuel, and a charging device for charging a battery with the power generated by the power generation device.

The power generation device of the hybrid vehicle may be a hybrid starter and generator (HSG), which is a type of motor that operates as a generator by receiving rotational power from an engine, or a drive motor for driving the vehicle, and the power generation device of the fuel cell vehicle may be a fuel cell system that includes a fuel cell stack that generates electrical energy by use of hydrogen and air as fuel, and an air supply device and a hydrogen supply device for operating the fuel cell stack.

Furthermore, the charging device of each of the hybrid vehicle and the fuel cell vehicle may include a power conversion device for charging a high-voltage battery, such as an inverter or converter.

For reference, a stay mode of an electrified vehicle to which the system of the present disclosure is applied refers to a vehicle mode in which while the vehicle is parked, the power generation device (e.g., a hybrid starter and generator or a drive motor) generates power with rotation power caused by engine idling to charge a battery, enabling rest or stay in the vehicle for a long time while battery power is continuously used. During such a stay mode, various electrical devices provided in the vehicle, such as an air conditioning device and infotainment device, and external electrical devices connected to outlets in the vehicle may be used.

Hereinafter, an exemplary embodiment of the present disclosure will be described in detail with reference to the appended drawings.

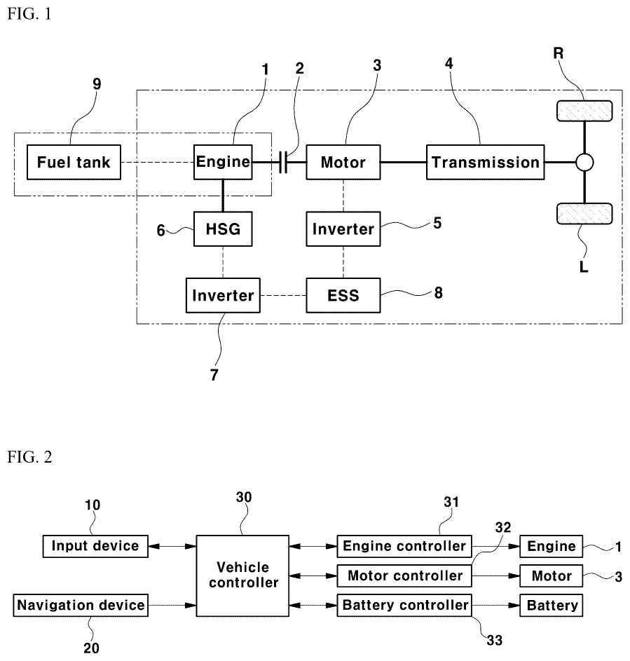

FIG. 1 is a powertrain diagram of a hybrid vehicle to which EV line variable control is applied according to an exemplary embodiment of the present disclosure, and FIG. 2 is a control schematic diagram illustrating an EV line variable control system for an electrified vehicle according to an exemplary embodiment of the present disclosure.

As illustrated in FIG. 1, a powertrain of a parallel hybrid vehicle includes an engine 1 and a motor 3, which are driving devices for driving the vehicle, an engine clutch 2 that connects the engine 1 and the motor 3 for power transmission therebetween, or disconnects the engine 1 and the motor 3, a transmission 4 that is connected to an output side of the motor 3 to transmit power to the wheels L and R of the vehicle, an inverter 5 for driving the motor 3, and an energy storage system (ESS) 8, which is a power source (electric power source) of the motor 3, and is connected to the motor 3 via the inverter 5 for charging and discharging the energy storage system (ESS) 8. The engine 1 is connected to the fuel tank 9.

Here, the motor 3 as a motor, which is a driving device for driving a vehicle, is a drive motor mounted as a vehicle driving source in a typical hybrid vehicle, and the energy storage system 8 may be one or both of a high-voltage battery and a capacitor.

Furthermore, a crankshaft of the engine is connected to the hybrid starter and generator (HSG) 6, which is a type of motor used to start the engine or generate power by use of rotational power transmitted from the engine.

In detail, the hybrid starter and generator 6 is connected to the engine 1 for constant power transmission thereto through a power transmission device such as a belt and pulley or a gear device to be operated as a motor or a generator, and is connected to the energy storage system 8 through an inverter 7 to be charged and discharged.

The inverters 5 and 7 convert a direct current of the energy storage system 8 into a three-phase alternating current to drive the motor 3 and the HSG 6 to apply the three-phase alternating current to the motor 3 or the HSG 6, or conversely, when the motor 3 and the HSG 6 are in power generation operation, an alternating current generated by the motor 3 and the HSG 6 is converted into a direct current to apply the direct current to the energy storage system 8.

Such a hybrid vehicle may be driven in an electric vehicle (EV) mode, which is a pure electric vehicle mode in which only the power of the motor 3 is used, or in a hybrid electric vehicle (HEV) mode in which the power of the engine 1 and the power of the motor 3 are used in combination. During braking or deceleration of the vehicle due to inertia (coasting), a regenerative braking mode may be performed in which kinetic energy of the vehicle is recovered as electrical energy through motor generation to charge the battery of the energy storage system 8.

According to an exemplary embodiment of the present disclosure, the EV line is variably controlled based on total driving energy and the required charging and discharging energy while the hybrid vehicle as described above is driving on a pre-set specific driving route to lower the EV line by a certain level compared to a previous EV line, thereby increasing the driving amount and driving time of an engine according to driver demand power, and a battery SOC is increased to a higher level than a reference SOC in advance by the generation of the power generation device according to engine operation before the vehicle reaches a destination of the vehicle for using the stay mode so that power for the stay mode may be efficiently used at the destination.

To the present end, for the EV line variable control, a vehicle controller 30, which is a higher-level controller, and lower-level controllers, such as an engine controller 31 that performs engine-on control or engine-off control according to signal commands from the vehicle controller 30, a motor controller 32 that is configured to control the operations of the hybrid starter and generator and the motor according to signal commands from the vehicle controller 30, and a battery controller 33 that performs battery charge and discharge control according to signal commands from the vehicle controller 30, may be used.

Alternatively, the EV line variable control may be performed by an integrated controller having the integrated functions of the higher-level controller and the lower-level controllers, or by a dedicated controller provided separately to perform only the EV line variable control.

Meanwhile, for the EV line variable control according to an exemplary embodiment of the present disclosure, the EV line variable control system includes an input device 10 and a navigation device 20 connected to the vehicle controller 30 to be configured for transmitting signals to the vehicle controller 30.

The input device 10 may include a switch electrically connected to the vehicle controller, a touchscreen of an audio, video, and navigation (AVN) device, or a mobile device communicatively connected to the vehicle controller.

The navigation device 20 searches for a driving route to a destination based on the input of the destination, determines a driving distance and driving time to the destination, and provides the vehicle controller 30 with information necessary for driving, such as traffic information to the destination, current location information of the vehicle on the driving route to the destination, and road gradient information to the destination.

Furthermore, the navigation device 20 may be configured to transmit, to the vehicle controller 30, information on a stay location around the vehicle where the stay mode may be executed and used, real-time vehicle location information obtained through a built-in Global Positioning System (GPS) receiver, the road gradient information to the stay location, and real-time traffic information to the stay location received from outside the vehicle.

The vehicle controller 30 is configured to determine the total driving energy required to reach the destination based on the traffic information, the current location information, the road gradient information which are EV line variable control information received from the navigation device.

Furthermore, the vehicle controller 30 is configured to determine the required charging and discharging energy based on a current battery SOC while driving from a departure point to the destination and a target battery SOC upon reaching the destination.

In the instant case, the current battery SOC is a value that changes depending on driving conditions when the vehicle drives from the departure point to the destination, and the target battery SOC is a value preset to use the stay mode at the destination.

Furthermore, the vehicle controller 30 is configured to determine an EV line variability amount based on the total driving energy and the required charging and discharging energy which are determined, and to determine a final EV line changed compared to the existing EV line based on the EV line variability amount.

Here, the EV line variable control method according to an exemplary embodiment of the present disclosure based on the above-mentioned configuration will be sequentially described.

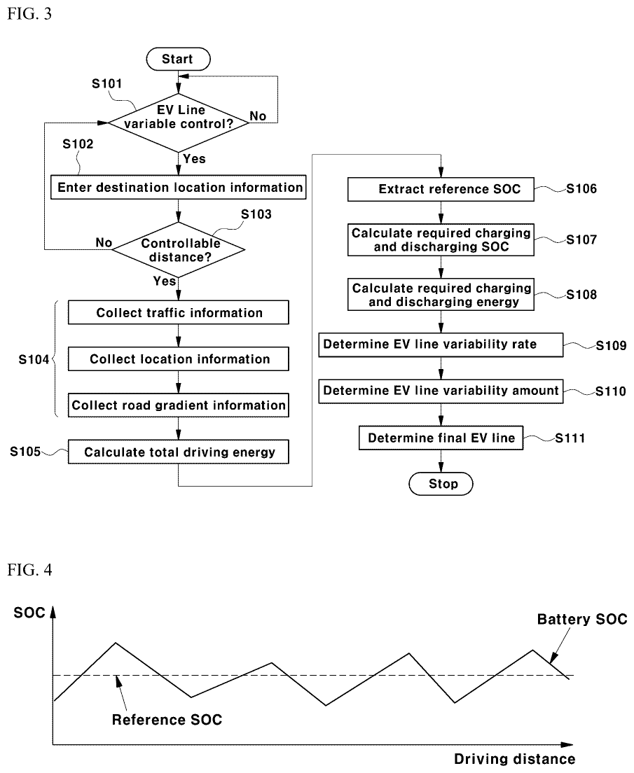

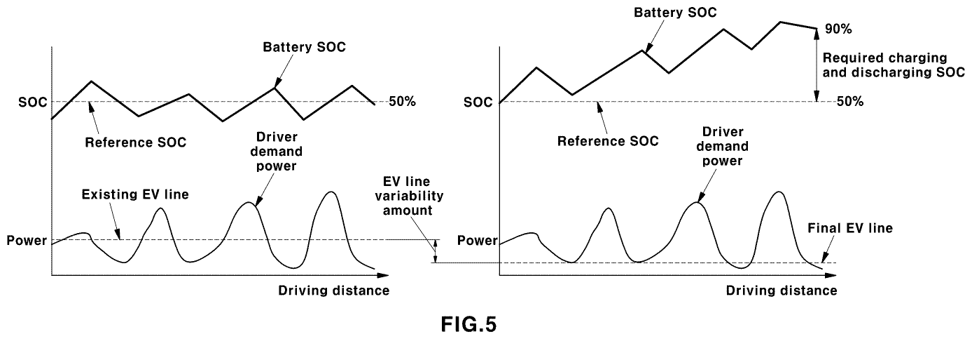

FIG. 3 is a flowchart illustrating an EV line variable control method of the vehicle controller 30 for an electrified vehicle according to an exemplary embodiment of the present disclosure, FIG. 4 is a graph illustrating a method for extracting a reference SOC for the EV line variable control of the electrified vehicle according to an exemplary embodiment of the present disclosure, and FIG. 5 is a graph illustrating an example of an EV line being adjusted downward compared to the existing EV line based on the EV line variable control method for an electrified vehicle according to an exemplary embodiment of the present disclosure.

First, it is determined whether the EV line variable control is performed in S101.

For example, when a driver selects the corresponding menu of the input device 10 and inputs a request to the input device 10 to perform the EV line variable control, the vehicle controller 30 may perform the EV line variable control.

Next, destination location information for the stay mode of the vehicle is input in S102.

For example, when a driver inputs the destination location information for the stay mode through the navigation device 20, the vehicle controller 30 may be configured to determine whether the EV line variable control is capable of being performed at the destination.

Next, it is determined whether a distance to the destination input through the navigation device 20 is a controllable distance (a distance at which the EV line variable control is possible), that is, whether the distance is appropriate to perform the EV line variable control in S103.

For example, in a case in which the current battery SOC is in the state of the target battery SOC higher than the reference SOC value, when a driving distance from the departure point to the destination for the stay mode is less than a reference distance, the consumption amount of the battery SOC is minimal even when the vehicle reaches the destination, and thus the current battery SOC at the destination may be maintained close to the target battery SOC level, so that the vehicle controller 30 determines the distance to the destination input through the navigation device 20 as an EV line variable control impossible distance.

In the instant case, after the vehicle controller 30 determines the distance to the destination input through the navigation device 20 as the EV line variable control impossible distance, a message indicating this is output on a display, so a driver may recognize that the corresponding destination is a destination at which the EV line variable control is not possible.

In an exemplary embodiment of the present invention, the input device 10 may include the display to show the message or additional output device may be connected to the vehicle controller 30 to display the message.

The display that outputs the message may be a navigation system, instrument panel, or head-up display (HUD).

On the other hand, when the driving distance from the departure point of the vehicle to the destination for the stay mode is greater than or equal to the reference distance, even if the battery is charged by regenerative braking when the vehicle is driving from the departure point to the destination, the battery discharge amount inevitably continues to increase, and accordingly, the current battery SOC at the destination is not able to meet the target battery SOC value, so that the vehicle controller 30 determines the distance to the destination input through the navigation device 20 as an EV line variable control possible distance.

Next, after the vehicle controller 30 determines the distance to the destination input through the navigation device 20 as the EV line variable control possible distance, the vehicle controller 30 collects driving route information from the departure point of the vehicle to the destination for the stay mode from the navigation device 20.

For example, the vehicle controller 30 collects the real-time traffic information, the vehicle location information, and the road gradient information which may be received from the navigation device 20 as the driving route information from the departure point of the vehicle to the destination for the stay mode in S104.

Accordingly, from the vehicle controller 30 may receive average vehicle speed information and vehicle acceleration/deceleration information of a driving road to the destination as the traffic information and may receive real-time vehicle location information as location information, so that the vehicle controller 30 may determine a remaining distance from a current vehicle location to a stay location, which is a destination, may determine an expected driving time from the remaining distance to the stay location, and may also determine grade resistance from the road gradient information.

Next, the vehicle controller 30 is configured to determine the total driving energy (x) required from the departure point to the destination based on the traffic information, the current location information, and the road gradient information collected as described above as well as predetermined basic vehicle information (a vehicle weight, a tire rolling radius, etc.) in S105.

For example, the vehicle controller 30 may be configured to determine each of vehicle air resistance, rolling resistance, grade resistance, and acceleration resistance in the driving route from the departure point to the destination, and determine the total driving energy (x) by integrating the air resistance, the rolling resistance, the grade resistance, and the acceleration resistance which are determined.

The air resistance may be determined by the mathematical expression 1 below, or may be a value that has been predetermined by the mathematical expression 1 below and mapped to a table.

$${R}_{d} = {c}_{d} \cdot A \cdot \frac{ρ}{2} \cdot {V}^{2} \qquad [ Mathematical expression 1 ]$$

In the mathematical expression 1 above, R_{d} represents air resistance, A represents vehicle frontal projection area, V represents vehicle relative speed to the wind, C_{d} represents air resistance coefficient, and ρ represents air density.

The rolling resistance may be determined by mathematical expression 2 and mathematical expression 3 below based on the road gradient information from the departure point to the destination in addition to the basic vehicle information.

$$\text{?} = \frac{e}{{r}_{dyn}} \cdot N = \text{?} \cdot W \cdot cos θ \qquad [ Mathematical expression 2 ]$$

$$[ Mathematical expression 3 ]$$

$$\text{?} = 11.6085 - 0.641769 \cdot {10}^{- 1} \cdot V + 0.927385 \cdot {10}^{- 2} \cdot {V}^{2} - 0.329934 \cdot {10}^{- 3} \cdot {V}^{3} + 0.667628 \cdot {10}^{- 5} \cdot {V}^{4} - 0.446194 \cdot {10}^{- 7} \cdot {V}^{5}$$

$$\text{?} \text{indicates text missing or illegible when filed}$$

In the mathematical expressions 2 and 3 above, Rᵣ represents rolling resistance, e represents vertical load offset due to tire deformation, r_{dyn} represents a tire rolling radius, N represents a vertical load acting on a tire, W represents vehicle weight, θ represents a vehicle gradient angle, V represents vehicle speed, and μᵣ represents rolling resistance coefficient.

The grade resistance may be determined by the mathematical expression 4 below based on the road gradient information from the departure point to the destination.

$${R}_{g} = W \cdot sin θ \qquad [ Mathematical expression 4 ]$$

In the mathematical expression 4 above, Rg represents the grade resistance, W represents vehicle weight, and θ represents vehicle gradient angle.

The acceleration resistance may be calculated by the mathematical expression 5 and mathematical expression 6 below. Since the acceleration resistance is force required to increase or decrease vehicle speed, and the rotation speed of an internal component (e.g., an engine) must also change, equivalent rotational inertia must be included in the vehicle weight for calculation.

$${R}_{a} = ( {m}_{vehicle} + {m}_{equivalent rotational inertia} ) \cdot a \qquad [ Mathematical expression 5 ]$$

$$[ Mathematical expression 6 ]$$

$${m}_{equivalent rotational inertia} = [ \text{} \frac{Total reduction ratio per gear}{{r}_{tire}} ] \cdot {I}_{equivalent rotational inertia shifted to engine}$$

In the mathematical expressions 5 and 6 above, Ra represents the acceleration resistance, m_{vehicle} represents vehicle weight, a represents acceleration, rₜᵢᵣₑ represents a tire rolling radius, and I represents equivalent rotational inertia acting on an engine side.

As described above, after the vehicle controller 30 may determine the vehicle air resistance, the rolling resistance, the grade resistance, and the acceleration resistance in the driving route from the departure point to the destination, the vehicle controller 30 may be configured to determine the total driving energy by integrating the air resistance, the rolling resistance, the grade resistance, and the acceleration resistance which are determined.

Meanwhile, the vehicle controller 30 is configured to determine the total driving energy and then is configured to determine the required charging and discharging energy based on the current battery SOC in the driving route from the departure point to the destination and the target battery SOC at a preset destination.

In the instant case, the current battery SOC may be a value that changes depending on driving conditions when the vehicle drives from the departure point to the destination, and the target battery SOC may be a value preset for using the stay mode at the destination.

Accordingly, the current battery SOC value, which is the battery SOC at a current point when the vehicle is driving from the departure point to the destination, may be provided from the battery controller 33 to the vehicle controller 30, and the target battery SOC may be preset to a level that allows the use of the stay mode at the destination when the distance to the destination is determined to be a controllable distance in S103 above.

First, to determine the required charging and discharging energy, the reference SOC is extracted from the vehicle controller 30 in S106.

Referring to FIG. 4, when a vehicle drives from the departure point to the destination, the battery SOC at the current point may vary to be more than the reference SOC or less than the reference SOC depending on charging and discharging. The reference SOC may be preset or may be an average value of battery SOCs that vary when the vehicle drives from the departure point to the destination. The present reference SOC may be provided from the battery controller 33 to the vehicle controller 30.

For example, assuming the reference SOC is a, the reference SOC a may be determined as the average value of the battery SOCs that vary when the vehicle drives for a predetermined driving time (e.g., 3 minutes) and a predetermined driving distance (e.g., 3 km) at a speed of 60 km/h or more.

Furthermore, to determine the required charging and discharging energy, the vehicle controller 30 is configured to determine required charging and discharging SOC in S107.

The required charging and discharging SOC may be determined at the current point when the vehicle is driving from the departure point to the destination, and may be determined from the reference SOC extracted as described above and the preset target battery SOC. When the required charging and discharging SOC is γ, the reference SOC is α, and the target battery SOC is β, the required charging and discharging SOC may be determined by γ=α−β, and the determined required charging and discharging SOC (γ) is determined as a value obtained by subtracting the target battery SOC (β) from the reference SOC (α). Therefore, the required charging and discharging SOC (γ) may be a (−) value when charging is required, and may be a (+) value when discharging is required.

Next, the vehicle controller 30 is configured to determine the required charging and discharging energy based on the reference SOC extracted in S106 described above and the required charging and discharging SOC value determined in S107 described above, and the required charging and discharging energy is determined based on battery capacity in S108.

The required charging and discharging energy is used in the EV line variable control to obtain the target battery SOC for the stay mode when the vehicle drives from the departure point to the destination. When the required charging and discharging SOC value determined in S107 described above is γ, the required charging and discharging energy is y, and the battery capacity is δ, the required charging and discharging energy may be determined by γ=γ×δ, and among the required charging and discharging energy, a required charging energy may be a (−) value, and a required discharging energy may be a (+) value.

Next, based on the total driving energy (x) determined in S105 described above and the required charging and discharging energy (y) determined in S108 described above, determining an EV line variability rate (ζ) in S109, determining the EV line variability amount (η) based on the EV line variability rate (ζ) in S110, and determining the final EV line changed compared to the existing EV line based on the EV line variability amount (η) in S111 are sequentially performed.

To the present end, the vehicle controller 30 determines an EV line variability rate (ζ) based on the total driving energy (x) determined in S105 described above and the required charging and discharging energy (y) determined in S108 described above, determines the EV line variability amount (η) based on the EV line variability rate (ζ), and determines the final EV line adjusted downward by a certain level compared to the existing (previous) EV line based on the EV line variability amount (η).

The EV line variability rate (ζ) may be determined as the ratio of the required charging and discharging energy (y) determined in S108 described above to the total driving energy (x) in an entire driving section (from the departure point to the destination) determined in S105 described above, as described in the mathematical expression 7 below.

the EV line variability rate (ζ)=the required charging and discharging energy (y)/the total driving energy (x) [Mathematical expression 7]:

The EV line variability amount (η) may be determined by multiplying the existing EV line by the EV line variability rate (ζ) determined by the mathematical expression 7 above.

As illustrated in FIG. 5, the final EV line may be determined to be at a level reduced by the EV line variability amount (η) compared to the existing (previous) EV line, that is, a level lowered by the EV line variability amount (η) compared to the existing (previous) EV line.

Accordingly, the vehicle controller 30 commands the engine controller 31 with the final EV line determined through the EV line variable control process according to S101 to S111 described above, so that the engine controller 31 performs engine-on control or engine-off control based on the final EV line.

For example, referring to FIG. 5, when driver demand power for driving a vehicle is equal to or greater than a first set value based on the existing (previous) EV line, an engine-on control was performed. However, unlike this, when driver demand power for driving a vehicle is a second set value lower by a certain level than the first set value based on the final EV line, the engine-on control may be performed.

Furthermore, during the engine-on control, the power generation device (e.g., the hybrid starter and generator) may be configured to generate power by rotation force generated by engine operation, and the generated power may be charged to a battery by the control of the battery controller 33.

In the present way, the engine-on control may be performed when the driver demand power is the second set value smaller by a certain level than the first set value based on the final EV line, so that engine driving amount and engine driving time may be increased while driving from the departure point to the destination, and accordingly, the battery SOC may be increased by the power generation of the power generation device (e.g., the hybrid starter and generator) according to engine driving. For example, as illustrated in FIG. 5, the battery SOC may be increased up to the target battery SOC (e.g., 90%) increased by 40% compared to the reference SOC (e.g., 50%) up to 90%.

Ultimately, the battery SOC may be controlled to a target battery SOC higher than the reference SOC before reaching the destination for using the stay mode through the EV line variable control as described above, facilitating power usage for the stay mode at the destination.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), Silicon Disk Drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like. Furthermore, the computer-readable recording medium may be distributed over computer systems connected through a network, and computer-readable program code may be stored and executed in a distributive manner.

In various exemplary embodiments of the present disclosure, each operation described above may be performed by a control device, and the control device may be configured by multiple control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well known to a person having ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, multiple operations may be merged, or any operation may be divided, and a specific operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “or” used in the present disclosure should be interpreted as indicating “additionally or alternatively.”

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

The terms used to describe the exemplary embodiments are used for describing specific embodiments, and are not intended to limit the embodiments. As used in the description of the exemplary embodiments and in the claims, the singular forms “a”, “an”, and “the” include plural referents unless the context clearly dictates otherwise. The expression “and/or” is used to include all possible combinations of terms.

In the exemplary embodiment of the present disclosure, it should be understood that a term such as “include” or “have” is intended to designate that the features, numbers, steps, operations, elements, parts, or combinations thereof described in the specification are present, and does not preclude the possibility of addition or presence of one or more other features, numbers, steps, operations, elements, parts, or combinations thereof.

As used herein, conditional expressions such as “if” and “when” are not limited to an optional case and are intended to be interpreted, when a specific condition is satisfied, to perform the related operation or interpret the related definition according to the specific condition.

Terms such as first and second may be used to describe various elements of the embodiments. However, various components according to the exemplary embodiments should not be limited by the above terms. These terms are only used to distinguish one element from another.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An EV line variable control system for an electrified vehicle, the system comprising:
an input device;
a vehicle controller;
a navigation device configured to provide the vehicle controller with EV line variable control information including traffic information, current location information, and road gradient information to a destination for a stay mode of the vehicle;
an energy storage system,
wherein the vehicle controller is operatively connected to the input device and the navigation device and configured to determine total driving energy required to reach the destination based on the EV line variable control information received from the navigation device according to a request of EV line variable control received through the input device, to determine required charging and discharging energy based on a current battery SOC value and a preset target battery SOC value of the energy storage system, and to determine an EV line variability amount and a final EV line based on the total driving energy and the required charging and discharging energy, and to perform engine-on control or engine-off control based on the final EV line.

2. The system of claim 1, further including a display operatively connected to the vehicle controller,
wherein the vehicle controller is further configured to determine a distance of the vehicle to the destination for the stay mode input through the navigation device as an EV line variable control impossible distance based on that the distance is less than a reference distance, to determine the distance as an EV line variable control possible distance based on that the distance is greater than or equal to the reference distance, and to output a message indicating the EV line variable control impossible distance on the display.

3. The system of claim 1, wherein the vehicle controller is further configured to determine vehicle air resistance, rolling resistance, grade resistance, and acceleration resistance based on information on average vehicle speed and at least one of vehicle acceleration information or vehicle deceleration information of a driving road to the destination, and information on a predetermined vehicle weight and a tire rolling radius as well as the traffic information, the current location information, and the road gradient information received from the navigation device, and to determine the total driving energy by integrating the air resistance, the rolling resistance, the grade resistance, and the acceleration resistance which are determined.

4. The system of claim 1, wherein the vehicle controller is further configured to determine a required charging and discharging SOC value by subtracting the target battery SOC from a reference SOC value, and to determine the required charging and discharging energy based on the required charging and discharging SOC value, which is determined, and a battery capacity of the energy storage system.

5. The system of claim 4, wherein the required charging and discharging energy is determined by multiplying the required charging and discharging SOC value by the battery capacity.

6. The system of claim 1, wherein the vehicle controller is further configured to determine an EV line variability rate based on the total driving energy and the required charging and discharging energy, to determine the EV line variability amount based on the EV line variability rate, and to determine the final EV line adjusted downward by a predetermined level compared to an existing EV line based on the EV line variability amount.

7. The system of claim 6, wherein the EV line variability rate is determined by dividing the required charging and discharging energy by the total driving energy.

8. The system of claim 6, wherein the EV line variability amount is determined by multiplying the existing EV line by the EV line variability rate.

9. The system of claim 6, wherein the final EV line is determined to be at a level reduced by the EV line variability amount compared to the existing EV line.

10. The system of claim 1, further including:
an engine controller operatively connected to the vehicle controller and configured to perform the engine-on control or the engine-off control based on the final EV line commanded from the vehicle controller;
a power generation device connected to an engine and configured to generate power by rotation force generated by engine operation during the engine-on control; and
a battery controller operatively connected to the vehicle controller and configured to control charging of the generated power of the power generation device into the energy storage system.

11. An EV line variable control method for an electrified vehicle, the method comprising:
determining, by a vehicle controller operatively connected to an input device, whether EV line variable control is possible according to a request of the EV line variable control received through the input device;
receiving, by the vehicle controller, EV line variable control information including traffic information, current location information, and road gradient information to a destination of the vehicle input through a navigation device operatively connected to the vehicle controller based on that the vehicle controller concludes that the EV line variable control is possible; and
determining, by the vehicle controller, total driving energy required to reach the destination based on the EV line variable control information received from the navigation device, determining required charging and discharging energy based on a current battery SOC value and a preset target battery SOC value of an energy storage system, determining an EV line variability amount and a final EV line based on the total driving energy and the required charging and discharging energy, and performing engine-on control or engine-off control based on the final EV line.

12. The method of claim 11, wherein in the determining of whether the EV line variable control is possible,
based on that a distance of the vehicle to the destination for a stay mode input through the navigation device is less than a reference distance, the distance is determined as an EV line variable control impossible distance, based on that the distance is greater than or equal to the reference distance, the distance is determined as an EV line variable control possible distance, and a message indicating the EV line variable control impossible distance is output on a display operatively connected to the vehicle controller.

13. The method of claim 11, wherein the total driving energy is determined, by the vehicle controller, by determining vehicle air resistance, rolling resistance, grade resistance, and acceleration resistance based on information on average vehicle speed and at least one of vehicle acceleration information or vehicle deceleration information of a driving road to the destination, and information of a predetermined vehicle weight and a tire rolling radius as well as the traffic information, the current location information, and the road gradient information received from the navigation device, and integrating the air resistance, the rolling resistance, the grade resistance, and the acceleration resistance which are determined.

14. The method of claim 11, wherein the required charging and discharging energy is determined, by the vehicle controller, based on a required charging and discharging SOC value determined by subtracting the target battery SOC from a reference SOC value, and a battery capacity of the energy storage system.

15. The method of claim 14, wherein the required charging and discharging energy is determined, by the vehicle controller, by multiplying the required charging and discharging SOC value by the battery capacity.

16. The method of claim 11, wherein based on that the EV line variability amount and the final EV line are determined,
an EV line variability rate is first determined, by the vehicle controller, based on the total driving energy and the required charging and discharging energy, the EV line variability amount is determined, by the vehicle controller, based on the EV line variability rate, and then the final EV line adjusted downward by a predetermined level compared to an existing EV line is determined, by the vehicle controller, based on the EV line variability amount.

17. The method of claim 16, wherein the EV line variability rate is determined, by the vehicle controller, by dividing the required charging and discharging energy by the total driving energy.

18. The method of claim 16, wherein the EV line variability amount is determined, by the vehicle controller, by multiplying the existing EV line by the EV line variability rate.

19. The method of claim 16, wherein the final EV line is determined, by the vehicle controller, to be at a level reduced by the EV line variability amount compared to the existing EV line.

20. The method of claim 11, further including:
performing, by an engine controller operatively connected to the vehicle controller and, the engine-on control or the engine-off control based on the final EV line commanded from the vehicle controller;
generating, by a power generation device connected to an engine, power by rotation force generated by engine operation during the engine-on control; and
controlling, by a battery controller operatively connected to the vehicle controller and, charging of the generated power of the power generation device into the energy storage system.
